(19) United States
(12) Patent Application Publication
(10) Pub. No.: US 2018/0016830 A1
(43) Pub. Date: Jan. 18, 2018

(54) HYDRAULIC HINGE

(71) Applicant: Audrius Macernis, SEAFORD (AU)

(72) Inventor: Audrius Macernis, SEAFORD (AU)

(21) Appl. No.: 15/208,700

(22) Filed: Jul. 13, 2016

(51) Int. Cl. E05F 3/14; E05F 3/20

(52) U.S. Cl. CPC E05F 3/14; E05F 3/20; E05Y 2900/40

(57) ABSTRACT

A hydraulic hinge disclosed here is attached to a gate to prevent an impact due to a quick opening and quick closing of the gate. The hydraulic hinge comprises a first hinge member and second hinge member, and a hydraulic damper. The first hinge member is defined by a cylindrical body comprising a longitudinal axis about which the second hinge member is rotatable to rotate the hydraulic hinge between an open position and a closed position. The hydraulic damper is positioned within a cavity of the cylindrical body, and comprises a shaft positioned within a housing, and a hydraulic fluid filled in a space defined between the shaft and the housing. The hydraulic damper is in communication with the second hinge member, to provide resistance against slamming of the gate when the shaft is internally rotated through the hydraulic fluid during a quick opening and quick closing of the gate.

### FIELD OF THE INVENTION

The present invention relates to improvements in gate hinges. More particularly, present invention relates to a hydraulic hinge for self-closing gates, where the gates are required to be softly closed, in the case, when the gate is slam opened or closed.

### BACKGROUND

One of the major concerns in the usage of gates nowadays, is the impact caused when the gates are slammed open or closed. It's required to soft close the gates to avoid damage to the gate as well as the gate post, during when the gate is slammed. Even though a standalone device can be employed to provide such resistive dampening force to soft close the gate, the best desired method is to incorporate the dampening functionality into the gate hinges itself for multiple value added reasons, such as, the overall aesthetics, operational safety, reduced cost of construction, etc. Therefore, in the construction of conventional gates, gate hinge assemblies are known to comprise damper elements, for example, hydraulic dampers. The main purpose of such conventional hydraulic dampers is to reduce the slamming effect of the gate when the gate is quick closed or opened. These hydraulic dampers provide a desired cushioning effect when the gate is slammed opened/closed.

However, there are some problems with the conventional hydraulic dampers. One of such hydraulic dampers is the one with the piston-cylinder mechanism as disclosed in the U.S. Pat. No. 4,829,628, wherein due to limited movement of the gate, that is, approximately 90° from closed position to open position, the displacement of the piston is significantly limited. Therefore, either a comparatively high standard of accuracy in construction is essential, or a comparatively larger size of the hinge is essential in order to accomplish the anticipated functionality. Another one of the prior art technologies is the one with the leaf-compartment mechanism as disclosed by the Chinese patent number 2074353, where a divider is required to be inserted into and fastened onto a cylinder body. This effectively increases the complexity in construction of the damping hinge as well as increases the cost of construction. Further, the positioning of the dividers also restricts the angle of operation.

Therefore, there is a need for a hydraulic hinge which addresses and resolves the above-mentioned issues, and which would have a durable design with efficient components to effectively avoid constant repair of the hinge mechanism, as well as provide desired soft closing characteristics.

### SUMMARY OF THE INVENTION

The hydraulic hinge addresses the above mentioned issues in the background. The hydraulic hinge is attached between a gate and a gate post, where the hydraulic hinge is configured to prevent an impact on the gate due to a quick opening and quick closing of the gate. The hydraulic hinge comprises a first hinge member and second hinge member, and a hydraulic damper. The first hinge member and second hinge member are movable between an open position and a closed position of the gate. The first hinge member is defined by a substantially cylindrical body comprising a longitudinal axis about which the second hinge member is rotatable to rotate the hydraulic hinge between an open position and a closed position, where the cylindrical body defines a cavity.

The hydraulic damper is positioned within cavity of the cylindrical body, where the hydraulic damper comprises a shaft positioned within a housing, and a hydraulic fluid filled in a space defined between the shaft and the housing. The hydraulic damper is in contact communication with the second hinge member, where the hydraulic damper is configured to provide resistance against slamming of the gate when the shaft is internally rotated in the presence of the hydraulic fluid during a quick opening and quick closing of the gate. In an embodiment, the hydraulic hinge further comprises plug members disposed and attached at an upper portion and a lower portion of the cylindrical body, where a first plug member comprises a first channel to receive the shaft of the hydraulic damper, and a second plug member comprises a second channel to receive an extended portion of the housing of the hydraulic damper.

In an embodiment, the second hinge member comprises two receptor rings disposed on opposing ends, where the receptor rings comprise a receptor channel to receive a protruding section, which extends outwardly from each plug member, thereby the second hinge member, is in rotatable communication with the hydraulic damper via the plug members. In an embodiment, the hydraulic hinge further comprises a plug adapter axially aligned and securing the shaft of the hydraulic damper within the cylindrical body. In an embodiment, the hydraulic hinge further comprises an safety cap positioned above the plug member, where the safety cap is configured to prevent a user from using the hydraulic hinge as a support to climb above the gate, for example, to prevent children from using the hydraulic hinge as a step for them to climb above the gate.

In an embodiment, the hydraulic damper further comprises a damper valve, where the shaft comprises an extended tab which is configured to receive the damper valve which is of a substantially wedge shape. In an embodiment, the hydraulic fluid is filled within the space defined by the damper housing, where the damper shaft is configured to rotate causing the damper valve to open and close, to allow the hydraulic fluid to be selectively compressed and transferred to the opposing sides of the damper shaft and the damper valve when assembled together within the space. In an embodiment, the hydraulic damper further comprises a rubber sealer positioned at the engagement between the damper valve and the shaft to provide sealing to the engagement thereof.

In an embodiment, the hydraulic damper further comprises an O ring member positioned on an upper annular ring section of the damper shaft, where the O ring member is configured to be compressed during assembly between the upper annular ring section of the damper shaft and a spacer member. Therefore, the O ring member creates a seal at the interface between the upper annular ring section and the spacer member. In an embodiment, the spacer member is configured to be seated around the shaft of the hydraulic damper. In an embodiment, the hydraulic damper further comprises a screw brushing member insert to seat a screw brushing around the shaft of the hydraulic damper.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1A exemplarily illustrates a perspective view of the hydraulic hinge.

FIG. 1B exemplarily illustrates a front elevation view of the hydraulic hinge.

FIG. 1C exemplarily illustrates a rear elevation view of the hydraulic hinge.

FIG. 2 exemplarily illustrates an exploded view of the hydraulic hinge.

FIG. 3 exemplarily illustrates an exploded view of the hydraulic damper.

### DETAILED DESCRIPTION OF THE INVENTION

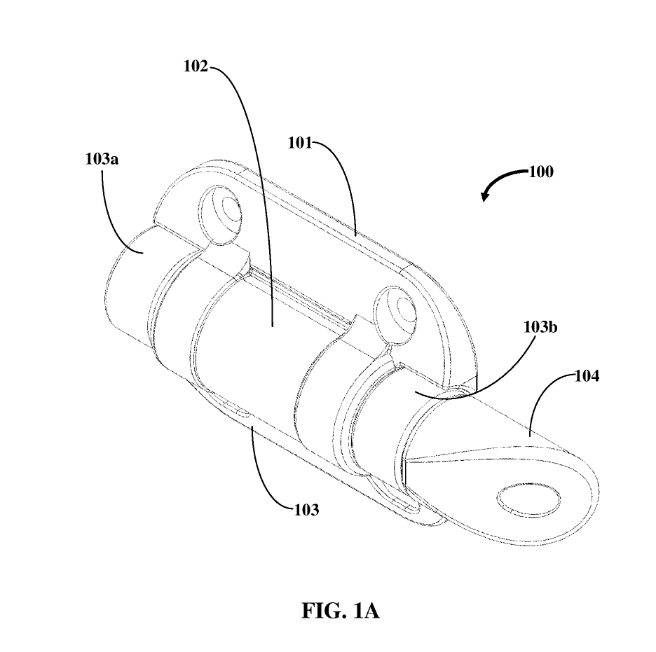

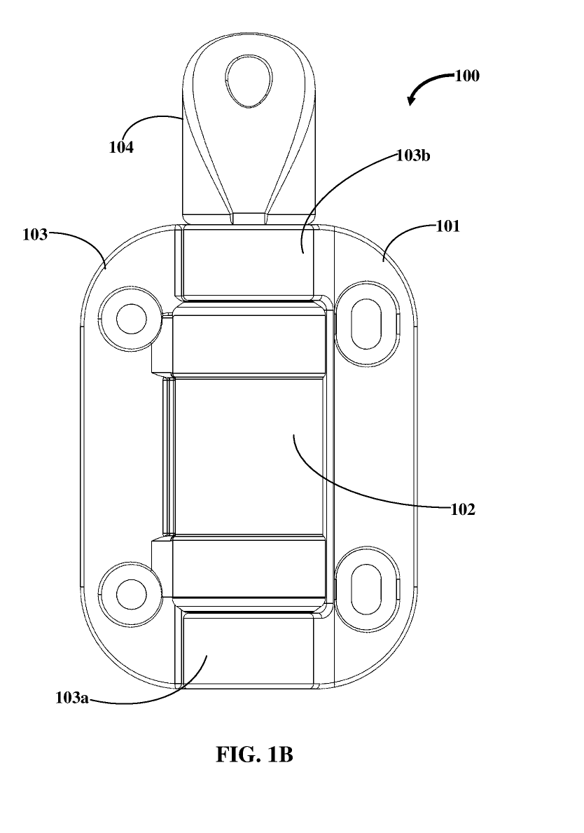

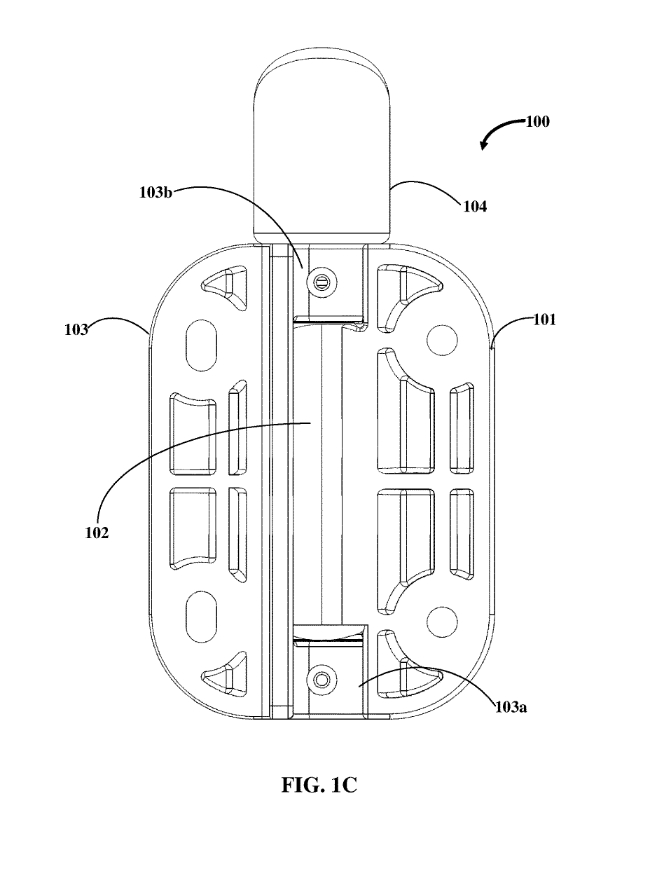

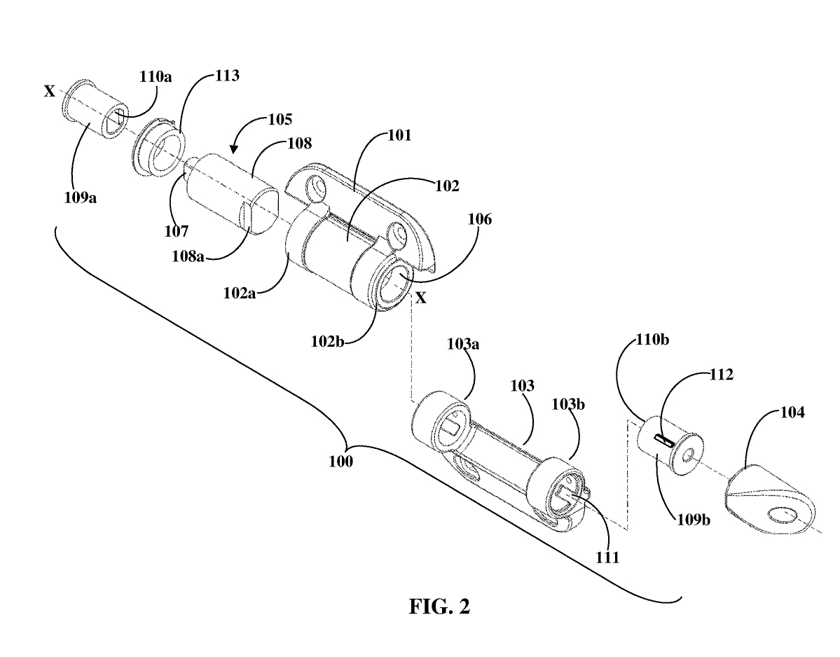

FIGS. 1A-1C exemplarily illustrate a perspective view, a front elevation view, and a real elevation view of the hydraulic hinge 100. The hydraulic hinge 100 is assembled mainly by axially coupling two hinge members 101 and 103. Here, a first hinge member 101 is axially aligned to a second hinge member 103, where the second hinge member 103 is enabled to rotate inside the first hinge member 101. Here, the first hinge member 101 is generally attached or fastened to a gate post, and the second hinge member 103 is generally attached or fastened to a gate. The hydraulic damper 106, as disclosed in the detailed description of FIG. 2, is positioned inside the hydraulic hinge 100 provides the internal cushioning for the gate inside the hydraulic hinge 100, during when the gate is slammed open or closed. Now, minimum two or more hydraulic hinges 100 are positioned on a gate and a gate post assembly to provide maximum resistance to slow down the impact caused by slamming of the gate, thereby providing a slow and soft closing of the gate. In another embodiment, one of these hydraulic dampers 106 is attached along with one or more spring loaded self-closing hinges on gates, where the hydraulic dampers 106 provide the resistance against slamming of the gate while the spring loaded self-closing hinges facilitate closing of the gates based on spring tension.

More number of hydraulic hinges 100 means better cushioning to the gate and gate post assembly. Further, as shown in the FIGS. 1A-1C, a pair of receptor rings 103a and 103b are positioned on the second hinge member 103 to receive the cylindrical body 102 of the first hinge member 101. The first hinge member 101 and the second hinge member 103 are in rotary communication along the receptor rings 103a and 103b and the cylindrical body 102, due to the axial alignment and engagement with each other. Further, an safety cap 104 is also positioned above one of the receptor rings 103a and 103b, as further disclosed in the detailed description of FIG. 2.

FIG. 2 exemplarily illustrates an exploded view of the hydraulic hinge 100. The hydraulic hinge 100 is configured to be attached between a gate and a gate post, where the hydraulic hinge 100 is configured to prevent an impact on the gate due to a quick opening and quick closing of the gate by a user. The hydraulic hinge 100 comprises a first hinge member 101 and second hinge member 103, and a hydraulic damper 105. The first hinge member 101 and second hinge member 103 are movable between an open position and a closed position, where the first hinge member 101 is defined by a substantially cylindrical body 102 comprising a longitudinal axis XX about which the second hinge member 103 is rotatable to rotate the hydraulic hinge 100 between an open position and a closed position, where the cylindrical body 102 defines a cavity 106.

The hydraulic damper 105 is positioned within cavity 106 of the cylindrical body 102, where the hydraulic damper 105 comprises a shaft 107 positioned within a housing 108, and a hydraulic fluid filled in a space defined between the shaft 107 and the housing 108. The hydraulic damper 105 is in contact communication with the second hinge member 103, where the hydraulic damper 105 is configured to provide resistance against slamming of the gate when the shaft 107 is internally rotated in the presence of hydraulic fluid during a quick opening and quick closing of the gate. In an embodiment, the hydraulic hinge 100 further comprises plug members 109a and 109b disposed and attached at an upper portion 102a and a lower portion 102b of the cylindrical body 102, where a first plug member 109a comprises a first channel 110a to receive the shaft 107 of the hydraulic damper 105, and a second plug member 109b comprises a second channel 110b to receive an extended portion 108a of the housing 108 of the hydraulic damper 105.

In an embodiment, the second hinge member 103 comprises two receptor rings 103a and 103b disposed on opposing ends, wherein the receptor rings 103a and 103b comprise a receptor channel 111 to receive a protruding section 112 which extends outwardly from each plug member 109a and 109b, thereby the second hinge member 103 is in rotatable communication with the hydraulic damper 105 via the plug members 109b and 109a. In an embodiment, the hydraulic hinge 100 further comprises a plug adapter 113 axially aligned and securing the shaft 107 of the hydraulic damper 105 within the cylindrical body 102. In an embodiment, the hydraulic hinge 100 further comprises an safety cap 104 positioned above the plug member 109b, where the safety cap 104 is configured to prevent a user from using the hydraulic hinge 100 as a support to climb above the gate, for example, the safety cap 104 is configured to prevent children from using the hydraulic hinge 100 as a step, for them to climb above the gate.

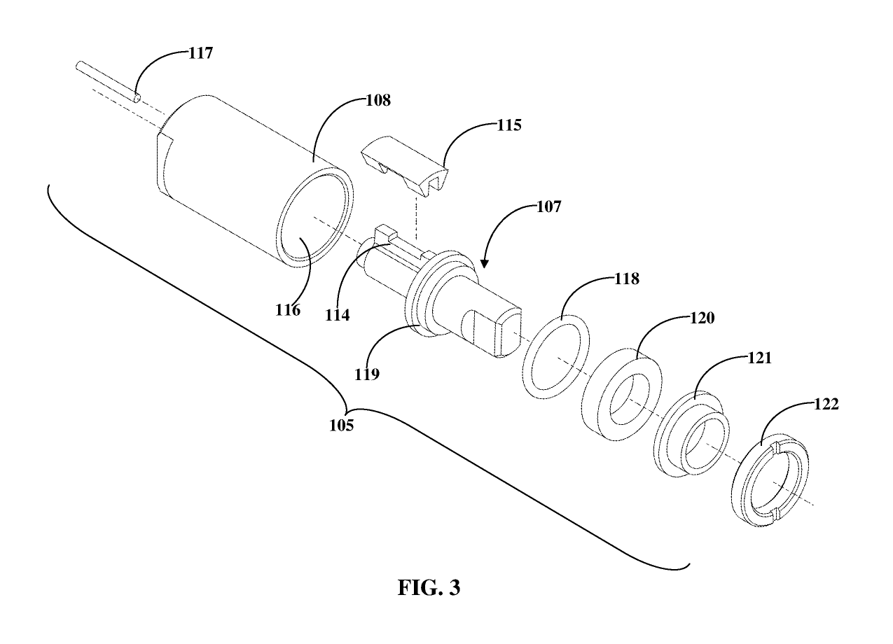

FIG. 3 exemplarily illustrates an exploded view of the hydraulic damper 105. The hydraulic damper 105 comprises the shaft 107 which is housed within a housing 108. The shaft 107 comprises an extended tab 114 which is configured to receive a damper valve 115 which is of a substantially wedge shape. In operation, the hydraulic fluid is filled within a space 116 defined by the housing 108, where the shaft 107 is configured to rotate causing the damper valve 115 to open and close, to allow the hydraulic fluid to be selectively compressed and transferred to the opposing sides of the shaft 107 and the damper valve 115 when assembled together within the space 116.

Further, a rubber sealer 117 is positioned at the engagement between the damper valve 115 and the shaft 107 to provide sealing to the engagement thereof. In an embodiment, an O ring member 118 is also positioned on an upper annular ring section 119 of the shaft 107, where the O ring member 118 is configured to be compressed during assembly between the upper annular ring section 119 of the shaft 107 and a spacer member 120, thereby creating a seal at the interface between the upper annular ring section 119 and the spacer member 120. The spacer member 120 is configured to be seated around the shaft 107 of the hydraulic damper 105, and a screw brushing member insert 121 is also positioned to seat a screw brushing 122 around the shaft 107 of the hydraulic damper 105.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A hydraulic hinge attached between a gate and a gate post, the hydraulic hinge configured to prevent an impact on the gate due to a quick opening and quick closing of the gate, the hydraulic hinge comprising;
a first hinge member and second hinge member movable between an open position and a closed position, the first hinge member defined by a substantially cylindrical body comprising a longitudinal axis about which the second hinge member is rotatable to rotate the hydraulic hinge between an open position and a closed position, wherein the cylindrical body defines a cavity;
a hydraulic damper positioned within cavity of the cylindrical body, wherein the hydraulic damper comprises a shaft positioned within a housing, and a hydraulic fluid filled in a space defined between the shaft and the housing, wherein the hydraulic damper is in contact communication with the second hinge member, wherein the hydraulic damper is configured to provide resistance against slamming of the gate when the shaft is internally rotated in presence of the hydraulic fluid during the quick opening and quick closing of the gate.

2. The hydraulic hinge according to claim 1, further comprises plug members disposed and attached at an upper portion and a lower portion of the cylindrical body, wherein a first plug member comprises a first channel to receive the shaft of the hydraulic damper, and a second plug member comprises a second channel to receive an extended portion of the housing of the hydraulic damper.

3. The hydraulic hinge according to claim 2, wherein the second hinge member comprises two receptor rings disposed on opposing ends, wherein the receptor rings comprise a receptor channel to receive a protruding section which extends outwardly from each plug member, thereby the second hinge member is in rotatable communication with the hydraulic damper via the plug members.

4. The hydraulic hinge according to claim 1, further comprises a plug adapter axially aligned with the shaft of the hydraulic damper, wherein the plug adapter secures the shaft of the hydraulic damper within the cylindrical body.

5. The hydraulic hinge according to claim 1, further comprises an safety cap positioned above the plug member, wherein the safety cap is configured to prevent a user from using the hydraulic hinge as a support to climb above the gate.

6. The hydraulic hinge according to claim 1, wherein the hydraulic damper further comprises a damper valve, wherein the shaft comprises an extended tab which is configured to receive the damper valve, wherein the damper valve is of a substantially wedge shape.

7. The hydraulic hinge according to claim 6, wherein the hydraulic fluid is filled within a space defined by the damper housing, wherein the damper shaft is configured to rotate causing the damper valve to open and close which allows the hydraulic fluid to be selectively compressed and transferred to the opposing sides of the shaft and the damper valve assembled together within the space.

8. The hydraulic hinge according to claim 6, wherein the hydraulic damper further comprises a rubber sealer positioned at the engagement between the damper valve and the shaft to provide sealing to the engagement thereof.

9. The hydraulic hinge according to claim 6, wherein the hydraulic damper further comprises an O ring member positioned on an upper annular ring section of the damper shaft, wherein the O ring member is configured to be compressed during assembly between the upper annular ring section of the damper shaft and a spacer member, thereby creating a seal at the interface between the upper annular ring section and the spacer member.

10. The hydraulic hinge according to claim 6, wherein the spacer member is configured to be seated around the shaft of the hydraulic damper.

11. The hydraulic hinge according to claim 6, wherein the hydraulic damper further comprises a screw brushing member insert to seat a screw brushing around the shaft of the hydraulic damper.
